(19) United States
(12) Patent Application Publication
(10) Pub. No.: US 2025/0154001 A1
(43) Pub. Date: May 15, 2025

(54) CONTROL PROCESS FOR LIQUID ORGANIC HYDROGEN CARRIER PROCESS

(71) Applicant: UOP LLC, Des Plaines, IL (US)

(72) Inventors: James W. Harris, Palatine, IL (US); Srinivasan Ramanujam, Tamilnadu (IN); Ian G. Horn, Streamwood, IL (US); Sara E. Horton, Hanover Park, IL (US)

(21) Appl. No.: 18/783,661

(22) Filed: Jul. 25, 2024

Related U.S. Application Data
(60) Provisional application No. 63/597,360, filed on Nov. 9, 2023.

(51) Int. Cl. C01B 3/00

(52) U.S. Cl. CPC C01B 3/0015; C01B 2203/0805; C01B 2203/0883; C01B 2203/148; C01B 2203/1619; C01B 2203/1633; C01B 2203/169

(57) ABSTRACT

Processes for controlling liquid organic hydrogen carrier processes are described. The processes include flow control of hydrogen as the primary variable with toluene make-up based on reactor conditions. Make-up hydrogen gas is provided via a flow controller which can be adjusted by the operator. A pressure controller on the separator is used to adjust the temperature at the reactors with a temperature controller. The inlet temperature to the reactors is maintained by heat exchangers, such as steam generators. The reaction conditions are monitored by temperature measurement and the inlet and/or the outlet of the reactor. When hydrogen feed rates are adjusted, the unit operations must increase or reduce the toluene to balance this situation. A differential temperature controller is used to reset the toluene flowrate to the reactor to achieve the desired processing objective.

### RELATED APPLICATIONS

This application claims priority to U.S. Provisional Patent Application Ser. No. 63/597,360, filed on Nov. 9, 2023, the entirety of which is incorporated herein by reference.

### BACKGROUND

Hydrogen is expected to have significant growth potential because it is a clean-burning fuel. Aggressive carbon emission reduction targets and rising carbon penalties for 2030-2050 to meet the Paris Climate Agreement are anticipated to drive a hydrogen-based economy in the near future.

However, hydrogen production processes based on steam reforming, autothermal reforming, partial oxidation, or gasification of hydrocarbon or carbonaceous feedstocks are significant emitters of CO₂. Government regulations and societal pressures are increasingly taxing or penalizing CO₂ emissions or incentivizing CO₂ capture. Consequently, there is significant interest in lowering the cost of hydrogen production using these processes and recovering the byproduct CO₂ for subsequent geological sequestration. Hydrogen from solar, wind, and water (Green Hydrogen), which does not involve the production of CO₂, could meet projected global energy demand in the future and play a vital role in reducing global warming. The recently renewed interest in alternative energy sources and energy carriers opens up new prospects for this process to be applied as a feed system for fuel cells, power generation and many more applications.

There exists a huge regional disparity in the cost of production of hydrogen. A number of technologies have been developed for transporting hydrogen, including NH₃, liquid H₂, and liquid organic hydrogen carrier (LOHC) to address this disparity. Toluene-Methylcyclohexane (MCH) is expected to be a significant player in the LOHC space considering numerous advantages, such as easy integration with existing fuel sector supply chain and distribution network, utilization in idle refinery assets, flexibility for co-processing, and higher relative handling safety.

LOHC involves the reversible dehydrogenation reaction of methylcyclohexane (MCH) to produce toluene and hydrogen through themethylcyclohexane dehydrogenation process. It has been proposed as a solution for the storage, transportation, and distribution of hydrogen produced from renewable energy sources. For power generation, the hydrogen from this process is usually compressed for the downstream power generation unit. Usually, the purity requirement for power generation unit is very stringent. Due to the relatively high cost associated with the green hydrogen production, it is necessary to recover almost all hydrogen.

The hydrogen supply depends on the availability of renewable energy, which is may subject to diurnal and other environmental factors. A typical refining process control scheme does not allow for the dynamic nature of this environment.

Accordingly, it would be desirable to have a control process which is able to control the process effectively in circumstances where the hydrogen flow is variable.

### BRIEF DESCRIPTION OF THE DRAWINGS

FIG. 1 is an illustration of one embodiment of a toluene saturation process and control system according to the present invention.

### DESCRIPTION

The liquid organic hydrogen carrier (LOHC) process involves hydrogenating toluene to methylcyclohexane (MCH) at a first location, transfer of the MCH to a second location, and dehydrogenating the MCH to toluene at the second location. It can be performed with minimal to no by-products, thereby ensuring minimal loss of hydrogen (green or blue hydrogen). MCH acts as a liquid organic hydrogen carrier, and it can be transferred in storage vessels and/or pipelines for several thousands of miles to the final destination with very minimal to no degradation. The LOHC process helps address the supply and demand gap of blue and green H₂ as well as the huge differential cost of production between regions.

The control scheme created for the LOHC process includes flow control of the hydrogen as the primary variable with toluene make-up based on reactor conditions. It also includes limits that will manage dynamic changes safely according to the limits calculated from models. The controls simplify operator input while maintaining the process within appropriate operating limits so that the reactors remain in safe operating condition. In addition, the process produces enough energy to sustain itself during normal operation. With the control system, the process can be reduced up to 50% of nameplate capacity (typically in the range of 30-50%) and still maintain a stable, self-sustaining operation, with the operator only needing to change one input to the process (the hydrogen flow). In addition, energy recovery has been improved such that the LOHC unit can generate up to 50% excess electricity (beyond what is consumed in the unit) at the nameplate capacity.

Make-up hydrogen gas is provided via a flow controller which can be adjusted by the operator. When using an upstream hydrogen generation technology that relies on renewable energy tied to natural elements (wind and solar for instance), the unit may need to adjust this value frequently to handle the changing availability of hydrogen.

A pressure controller on the separator is used to adjust the temperature at the reactors with a temperature controller. The inlet temperature to the reactors is maintained by heat exchangers, such as steam generators.

The reaction conditions are monitored by temperature measurement and the inlet and/or the outlet of the reactor. Generally, this will involve monitoring the differential temperature on each reactor. When hydrogen feed rates are adjusted, the unit operations must increase or reduce the toluene to balance this situation. A differential temperature controller is used to reset the toluene flowrate to the reactor to achieve the desired processing objective. When the supply of hydrogen is maximized, the differential temperature controller on the reactor will also be driven to its maximum allowable point to ensure complete toluene conversion (and hydrogen intake). When the supply of hydrogen is limited, the differential temperature controller on the reactor is adjusted to reduce the amount of toluene. This will match the hydrogen, reaction performance, and toluene use without requirement of many manual calculation and adjustments by the operator.

To ensure smooth transitions, the control system will include override limits on the temperature controller to ramp changes over time and to limit setpoints to the maximum and minimum allowable operating points. This further enhances the unit performance, especially while responding to the changing conditions of the hydrogen supply.

To prevent the operator from making changes faster than allowed, there will be high and low separator pressure control over-rides on the hydrogen feed flow.

Another advantage of this approach is the optimization of energy in the system. With these transitions well managed the unit can move from one stage to another with minimum excess energy use. The reactor inlet temperatures are maintained fairly constant while the changing outlet temperatures are met with automated responses to maintain the unit performance.

A start-up heater is needed to initiate the operation. This is used to increase the reaction inlet temperature. Auxillary steam is also needed at startup to provide heat to the reboilers (oxygen stripper and stabilizer) before the reaction is initiated and the unit becomes self-sufficient. Commonly a fired heater using fuel gas, natural gas or hydrogen could be used. An alternate approach to use an electric steam boiler will reduce the dependence on outside fuel sources or consuming the valuable hydrogen needed for the reaction.

Excess energy is exported as power produced on a steam generator from the medium pressure (MP) steam header. This fully utilizes this energy without the need to export steam and expect others to use it.

The hydrogenation reaction section comprises two or more hydrogenation reactors. A hydrocarbon stream comprising toluene is split into two or more streams. The first toluene stream is sent to the first hydrogenation reactor where the toluene is hydrogenated into methylcyclohexane. The first saturated reactor effluent stream is sent to a second hydrogenation reactor along with the second hydrocarbon stream where toluene is hydrogenated to produce additional methylcyclohexane. There can be one or more additional hydrogenation reactors between the first and second hydrogenation reactors. The second saturated reactor effluent is sent to a polishing reactor for additional reaction of toluene to methylcyclohexane.

Hydrogen is present in the first and second hydrogenation reactors. It can be added to the hydrocarbon feed stream, first hydrocarbon stream, the first hydrogenation reactor, the second hydrocarbon stream, the second hydrogenation reactor, or combinations thereof. The final reactor can be considered the polishing reactor, as the toluene concentration is greatly reduced before entering this reactor and the differential temperature (reaction functions) is expected to be very low.

The polishing reactor effluent is separated in a high-pressure separator into a liquid stream comprising methylcyclohexane and a vapor stream comprising hydrogen. At least a portion of the hydrogen in the first and/or second hydrogenation reactors (whether added to the reactor or mixed with the hydrocarbon feed stream and/or the first and/or second hydrocarbon streams) comes from the vapor stream.

The liquid stream is split into an optional recycle hydrocarbon stream and a second liquid stream. The optional recycle hydrocarbon stream can optionally be recycled to the first and/or second hydrogenation reactors (whether added directly to the first and/or second hydrogenation reactors or by mixing with the hydrocarbon feed stream and/or the first and/or second hydrocarbon streams).

The second liquid stream is sent to a stabilizer column to remove dissolved gases to form a product stream comprising methylcyclohexane. The second liquid stream can be sent through a pressure recovery turbine before it is stabilized to generate power and the power can be utilized in the hydrogenation process or exported to a second process.

Part of the off-gas stream from the stabilizer overhead stream can be recycled to a make-up gas compressor suction.

A portion of the vapor stream from the separator may optionally be passed through a membrane or sponge oil system forming a hydrogen rich stream and a byproduct rich reject stream. The hydrogen rich stream may be compressed in one or more compressors and sent to the first and/or second hydrogenation reactors and/or mixed with the hydrocarbon feed stream, and/or the first and/or second hydrocarbon streams. When a membrane is used, the hydrogen rich stream is the hydrogen rich permeate stream, and the byproduct reject stream is the byproduct rich retentate stream. The portion of the vapor stream sent through the membrane or sponge oil system is typically in the range of 1 to 35%.

The hydrocarbon feed stream can be pre-heated using the heat of reaction from the first hydrogenation reactor and/or the second hydrogenation reactor.

A steam stream can optionally be generated from the heat of reaction of one of the hydrogenation reactors, and the steam stream can be superheated using the heat of reaction of another hydrogenation reactor. The superheated steam stream can be used to generate power. The power can be used in the hydrogenation process or exported to another process.

The hydrocarbon feed stream, the hydrogen, or both can be treated in an adsorbent bed to remove contaminants.

Any suitable hydrogenation catalysts may be used as the first, intermediate, second, and polishing hydrogenation catalysts. The first, intermediate, second, and/or polishing catalysts can be the same or different. The hydrogenation catalyst should have high selectivity and a low rate of coke lay down. Suitable hydrogenation catalysts for the first, intermediate, second, and/or polishing hydrogenation catalyst include, but are not limited to, a metal of Group VIII of the Periodic Table and optionally a metal of Group I of the Periodic Table. Suitable hydrogenation catalysts for the first, intermediate, second, and/or polishing hydrogenation catalyst also include, but are not limited to, 0.5 wt % to 30 wt % of a metal of Group VIII of the Periodic Table and optionally 0.1 wt % to 1 wt % of a metal of Group I of the Periodic Table.

Typical operating pressures for the first and second reactors are in the range of 1034-6895 kPa(g) (150 to 1000 psig), or 2758-4482 kPa(g) (400 to 650 psig). Typical inlet temperatures for all of the reactors are in the range of 204-232° C. (400-450° F.). Typical outlet temperatures for the first and second reactors (and any additional reactors) are in the range of 316-371° C. (600-700° F.). Typical outlet temperatures for the polishing reactor are in the range of 218-260° C. (425-500° F.)

The polishing reactor may have an inlet temperature at least 10-20° C. higher than a dew point of the second (or later) reactor effluent stream.

The product stream comprising the methylcyclohexane is then transferred to a second location. The methylcyclohexane feed from the storage tanks which may not be completely dry or properly nitrogen-blanketed may be treated in an oxygen stripper before being routed to the dehydrogenation reactor section. The methylcyclohexane feed is mixed with a recycle methylcyclohexane stream from a deisoheptanizer column. The combined methylcyclohexane feed is mixed with recycle hydrogen and then preheated by exchange with the reactor effluent in a combined feed exchanger (CFE). The combined feed is then raised to the reaction temperature in the convection section of a charge heater and sent to the dehydrogenation reactor section comprising one or more dehydrogenation reactor(s). The combined feed passes through the dehydrogenation reactor(s). The dehydrogenation reactor(s) are typically downflow or radial flow reactors. Interheaters are used to raise the reactor effluent back to the desired reactor inlet temperature for the next dehydrogenation reactor. The effluent from the last dehydrogenation reactor is cooled in the combined feed exchanger and the product condenser before passing to the separator.

The separator vapor is compressed by the recycle gas compressor and split into net gas and recycle gas. The recycle gas is sent back to the combined feed exchanger to be mixed with the feed. The net gas is the hydrogen gas product stream and is sent to the hydrogen gas compression section. Toluene-rich liquid from the separator is pumped to the stabilizer column.

The hydrogen gas compression section comprises one or more hydrogen gas compressor(s) which provide sufficient pressure to meet the hydrogen purity requirements of the user. The hydrogen purity increases through each stage of compression. In addition, there is some liquid product recovered that is sent to the stabilizer column.

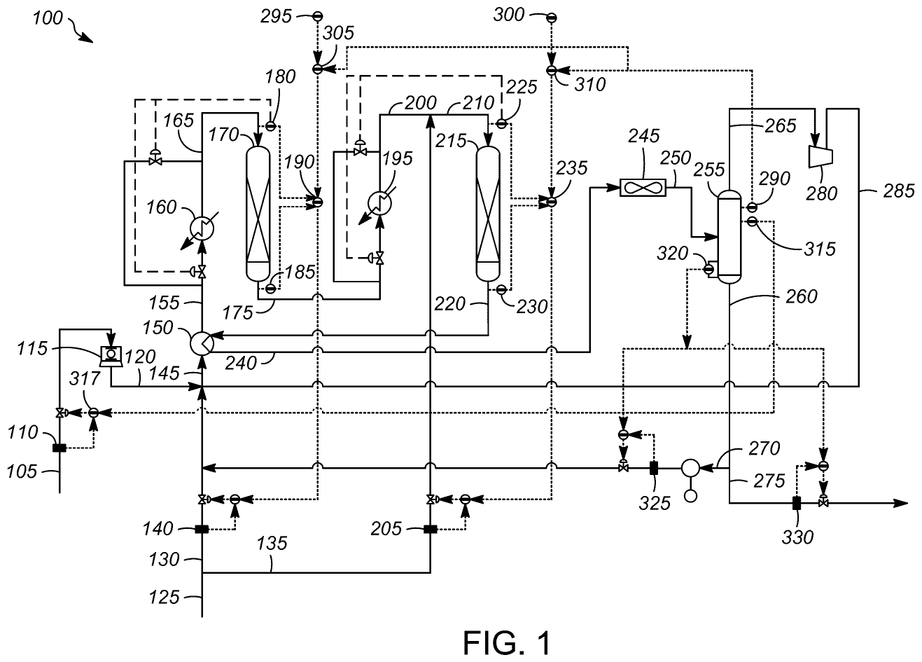

FIG. 1 illustrates one embodiments of a toluene hydrogenation process 100. The make-up hydrogen feed stream 105 passes through hydrogen flow controller 110 and is compressed in make-up compressor 115 forming compressed hydrogen feed stream 120.

The make-up toluene stream 125 is split into first toluene stream 130 and second toluene stream 135. The first toluene stream 130 passes through first toluene flow controller 140 and is mixed with compressed hydrogen feed stream 120 forming mixed feed stream 145.

The mixed feed stream 145 is preheated in heat exchanger 150 forming preheated mixed feed stream 155 which is further heated in steam heater 160 or cooled in the boiler feed water preheater 160 to achieve the target inlet temperature of first hydrogenation reactor 170. Suitable heat sources include, but are not limited to, steam heaters, fired heaters, hot oil heaters, electric heaters, or combinations thereof. Suitable cooling sources include, but are not limited to, steam generators, heat exchangers, fired heaters, hot oil heaters, electric heaters, or combinations thereof. The heated mixed feed stream 165 is sent to the first hydrogenation reactor 170 where the toluene is converted to MCH. The first reactor effluent stream 175 comprising MCH, and unreacted toluene and hydrogen, exits the first hydrogenation reactor 170.

There is a first inlet temperature controller 180 measuring and controlling the temperature of the heated mixed feed stream 165 entering the first hydrogenation reactor 170, and a first outlet temperature indicator 185 measuring the temperature of the first reactor effluent stream 175 exiting the first hydrogenation reactor 170. The first inlet temperature controller 180 and first outlet temperature indicator 185 are connected to first differential temperature controller 190.

Steam is produced in steam generator 195, and the first reactor effluent stream 175 is cooled forming cooled first reactor effluent stream 200.

The second toluene stream 135 is passed through second toluene flow controller 205 and is mixed with the cooled first reactor effluent stream 200 forming second mixed feed stream 210 which is sent to the second hydrogenation reactor 215 where the toluene is converted to additional MCH. The second reactor effluent stream 220, comprising MCH, and unreacted toluene and hydrogen, exits the second hydrogenation reactor 215.

There is a second inlet temperature controller 225 measuring and controlling the temperature of the second mixed feed stream 210 entering the second hydrogenation reactor 215, and a second outlet temperature indicator 230 measuring the temperature of the second reactor effluent stream 220 exiting the second hydrogenation reactor 215. The second inlet temperature controller 225 and second outlet temperature indicator 230 are connected to second differential temperature controller 235.

The second reactor effluent stream 220 is heat exchanged with the mixed feed stream 145 in heat exchanger 150. The cooled second reactor effluent stream 240 is sent to the separator inlet condenser 245, and the condensed stream 250 is sent to the separator 255 where it is separated into separator liquid stream 260 comprising MCH and separator overhead vapor stream 265 comprising hydrogen and light ends.

The separator liquid stream 260 is divided into recycle liquid stream 270 and liquid stream 275. The recycle liquid stream 270 is combined with first toluene stream 130. The liquid stream 275 is sent to a stabilizer column (not shown).

The separator overhead stream 265 is compressed in recycle gas compressor 280, and the compressed separator overhead stream 285 is combined with compressed hydrogen feed stream 120 and first toluene stream to form mixed feed stream 145.

There is a first pressure controller 290 on the separator 255 which is connected to first differential temperature controller 190 and second differential temperature controller 235. First differential temperature controller 190 is connected to first toluene flow controller 140, and second differential temperature controller 235 is connected to second toluene flow controller 205. When the first pressure controller 290 on the separator 255 indicates that the pressure has increased, the setpoints of the first and second differential temperature controllers increase. This increase in setpoint values will increase the first and second toluene feed rates with the first and second toluene flow controllers 140 and 205. Conversely, when the first pressure controller 290 on the separator 255 indicates the pressure has decreased, the setpoints of the first and second differential temperature controllers decrease. This decrease in setpoint values will decrease the first and second toluene feed rates with the first and second toluene flow controllers 140 and 205.

The first inlet temperature controller 180, first outlet temperature indicator 185, and first differential temperature controller 190 are used to control the inlet temperature to the first hydrogenation reactor 170, or the differential temperature of the first hydrogenation reactor 170, or both. The second inlet temperature controller 225, second outlet temperature indicator 230, and second differential temperature controller 235 are used to control the inlet temperature to the second hydrogenation reactor 215, or the differential temperature of the second hydrogenation reactor 215, or both. The first and second inlet temperature controllers 180 and 225 control the reactor inlet temperature by modulating the bypass of the heat exchangers 160 and 195. First and second differential temperature controllers 190 and 235 reset first and second toluene flow controllers 140 and 205 to adjust the toluene feed.

There is a first hand indicating controller 295 connected between first pressure controller 290 and first differential temperature controller 190, and a second hand indicating controller 300 connected between first pressure controller 290 and second differential temperature controller 235. The first and second hand indicating controllers 295 and 300 maintain the minimum toluene flow into the first and second hydrogenation reactors 170 and 215. This ensures safe operation by avoiding a very low flow or no flow condition.

There is a first high signal selector 305 connected between first pressure controller 290 and the first hand indicating controller 295. The higher signal output from either controller is passed to the first differential temperature controller 190, and a second high signal selector 310 connected between first pressure controller 290 and the second hand indicating controller 300. The higher signal output from either controller is passed to the second differential temperature controller 235. The first and second high signal selectors 305 and 310 pass along the higher setpoint from the first pressure controller 290 and the first and second hand indicating controllers 295 and 300. Normally, the pressure controller signal will be lower and be passed to the first and second differential temperature controllers 190 and 235. However, if this signal is below the hand controller signal, the hand controller signal will be passed along to maintain the minimum differential temperature and toluene flow.

There is a second pressure controller 315 on the separator 255 which is connected to the hydrogen flow controller 110. The second pressure controller 315 limits the changes to the hydrogen flow controller 110. If the setting is too high, it will limit the setpoint, and if it is too high, it will limit the setpoint. There is a low signal selector 317 which chooses the hydrogen flow controller output or the pressure controller output as the flow control valve opening. The hydrogen flow rate must be maintained at a minimum value to pressurize the separator 255 while not being too high and requiring venting of the separator vapor.

There is a level controller 320 on the separator 255 which is connected to the recycle flow controller 325 for the recycle liquid stream 270 and to the liquid flow controller 330 for the liquid stream 275. When the level controller 320 indicates the liquid level in the separator has increased or decreased, the recycle flow controller 325 and liquid flow controller 330 are opened or closed to bring the liquid level within the desired limits.

### SPECIFIC EMBODIMENTS

While the following is described in conjunction with specific embodiments, it will be understood that this description is intended to illustrate and not limit the scope of the preceding description and the appended claims.

A first embodiment of the invention is a process for controlling a liquid organic hydrogen carrier (LOHC) process comprising measuring a pressure of a separator; controlling a hydrogenation reactor using a first pressure controller and a first differential temperature controller based on the measured pressure of the separator; measuring an inlet temperature or an outlet temperature or both of the hydrogenation reactor; controlling the inlet temperature of the hydrogenation reactor using a first inlet temperature controller and a heat source or a cooling source based on the measured inlet temperature; controlling a flow rate of hydrogen to the hydrogenation reactor using a hydrogen flow controller and a second pressure controller limiting a flow rate of a source of hydrogen; and controlling a differential temperature of the hydrogenation reactor using a toluene flow controller and the measured inlet temperature and the measured outlet temperature of the hydrogenation reactor. An embodiment of the invention is one, any or all of prior embodiments in this paragraph up through the first embodiment in this paragraph further comprising selecting a predetermined maximum temperature and a predetermined minimum temperature for the hydrogenation reactor; and overriding the first inlet temperature controller if the measured temperature is greater than the predetermined maximum temperature or if the measured temperature is less than the predetermined minimum temperature. An embodiment of the invention is one, any or all of prior embodiments in this paragraph up through the first embodiment in this paragraph further comprising selecting a predetermined maximum temperature rate of change and a predetermined minimum temperature rate of change for the hydrogenation reactor; determining a temperature rate of change for the hydrogenation reactor; and overriding the first inlet temperature controller if the determined temperature rate of change is greater than the predetermined maximum temperature rate of change or if the determined temperature rate of change is less than the predetermined minimum temperature rate of change. An embodiment of the invention is one, any or all of prior embodiments in this paragraph up through the first embodiment in this paragraph wherein controlling the differential temperature of the hydrogenation reactor comprises controlling a toluene flow rate into the hydrogenation reactor based on a difference between the measured inlet temperature and the measured outlet temperature. An embodiment of the invention is one, any or all of prior embodiments in this paragraph up through the first embodiment in this paragraph further comprising selecting a predetermined maximum temperature differential and a predetermined minimum temperature differential between the inlet temperature and the outlet temperature of the hydrogenation reactor; determining a temperature differential between the measured inlet temperature and the measured outlet temperature of the hydrogenation reactor; and overriding the first differential temperature controller if the temperature differential is greater than the predetermined maximum temperature differential or the temperature differential is less than the predetermined minimum temperature differential. An embodiment of the invention is one, any or all of prior embodiments in this paragraph up through the first embodiment in this paragraph further comprising selecting a predetermined maximum pressure and a predetermined minimum pressure for the separator; and overriding the first pressure controller or the second pressure controller or both if the measured pressure is greater than the predetermined maximum pressure or if the measured pressure is less than the predetermined minimum pressure. An embodiment of the invention is one, any or all of prior embodiments in this paragraph up through the first embodiment in this paragraph further comprising controlling a recycle stream from the separator to the hydrogenation reactor using a level controller on the separator and a recycle flow controller. An embodiment of the invention is one, any or all of prior embodiments in this paragraph up through the first embodiment in this paragraph further comprising controlling a recycle stream from the separator to the hydrogenation reactor and a product stream using a level controller on the separator, a recycle flow controller, and a product flow controller. An embodiment of the invention is one, any or all of prior embodiments in this paragraph up through the first embodiment in this paragraph wherein the heat source comprises a steam heater, fired heater, hot oil heater, electric heater, or combinations thereof, and wherein the cooling source comprises a heat exchanger with a process stream having a lower temperature than the measured temperature. An embodiment of the invention is one, any or all of prior embodiments in this paragraph up through the first embodiment in this paragraph further comprising controlling a temperature of a second hydrogenation reactor using the first pressure controller and a second differential temperature controller based on the measured pressure of the separator; measuring an inlet temperature or an outlet temperature or both of the second hydrogenation reactor; controlling the inlet temperature of the second hydrogenation reactor using a second inlet temperature controller and a second cooling source based on the measured temperature; and controlling a differential temperature of the second hydrogenation reactor using a second toluene flow controller and the measured inlet temperature and the measured outlet temperature of the second hydrogenation reactor. An embodiment of the invention is one, any or all of prior embodiments in this paragraph up through the first embodiment in this paragraph wherein the second cooling source comprises a steam generator, a heat exchanger, fired heater, hot oil heater, electric heater, or combinations thereof.

A second embodiment of the invention is a process for controlling a liquid organic hydrogen carrier (LOHC) process comprising measuring a pressure of a separator; controlling a hydrogenation reactor using a first pressure controller and a first differential temperature controller based on the measured pressure of the separator; measuring an inlet temperature or an outlet temperature or both of the hydrogenation reactor; controlling an inlet temperature of the hydrogenation reactor using a first inlet temperature controller and a heat source or a cooling source based on the measured inlet temperature; controlling a flow rate of hydrogen to the hydrogenation reactor using a hydrogen flow controller and a second pressure controller limiting a flow rate of a source of hydrogen; controlling differential temperature of the hydrogenation reactor using a toluene flow controller and the measured inlet temperature and the measured outlet temperature of the hydrogenation reactor; controlling an inlet temperature of a second hydrogenation reactor using the first pressure controller and a second differential temperature controller based on the measured pressure of the separator; measuring an inlet temperature or an outlet temperature or both of the second hydrogenation reactor; controlling the inlet temperature of the second hydrogenation reactor using a second inlet temperature controller and a second cooling source based on the measured temperature; controlling a differential temperature of the second hydrogenation reactor using a second toluene flow controller and the measured inlet temperature and the measured outlet temperature of the second hydrogenation reactor. An embodiment of the invention is one, any or all of prior embodiments in this paragraph up through the second embodiment in this paragraph further comprising selecting a predetermined maximum temperature and a predetermined minimum temperature for the hydrogenation reactor; and overriding the first inlet temperature controller if the measured temperature is greater than the predetermined maximum temperature or if the measured temperature is less than the predetermined minimum temperature. An embodiment of the invention is one, any or all of prior embodiments in this paragraph up through the second embodiment in this paragraph further comprising selecting a predetermined maximum temperature rate of change and a predetermined minimum temperature rate of change for the hydrogenation reactor; determining a temperature rate of change for the hydrogenation reactor; and overriding the first inlet temperature controller if the determined temperature rate of change is greater than the predetermined maximum temperature rate of change or if the determined temperature rate of change is less than the predetermined minimum temperature rate of change. An embodiment of the invention is one, any or all of prior embodiments in this paragraph up through the second embodiment in this paragraph wherein controlling the differential temperature of the hydrogenation reactor comprises controlling a toluene flow rate into the hydrogenation reactor based on a difference between the measured inlet temperature and the measured outlet temperature. An embodiment of the invention is one, any or all of prior embodiments in this paragraph up through the second embodiment in this paragraph further comprising selecting a predetermined maximum temperature differential and a predetermined minimum temperature differential between the inlet temperature and the outlet temperature of the hydrogenation reactor; determining a temperature differential between the measured inlet temperature and the measured outlet temperature of the hydrogenation reactor; and overriding the first differential temperature controller if the temperature differential is greater than the predetermined maximum temperature differential or the temperature differential is less than the predetermined minimum temperature differential. An embodiment of the invention is one, any or all of prior embodiments in this paragraph up through the second embodiment in this paragraph further comprising selecting a predetermined maximum pressure and a predetermined minimum pressure for the separator; and overriding the first pressure controller or the second pressure controller or both if the measured pressure is greater than the predetermined maximum pressure or if the measured pressure is less than the predetermined minimum pressure. An embodiment of the invention is one, any or all of prior embodiments in this paragraph up through the second embodiment in this paragraph further comprising controlling a recycle stream from the separator to the hydrogenation reactor using a level controller on the separator and a recycle flow controller. An embodiment of the invention is one, any or all of prior embodiments in this paragraph up through the second embodiment in this paragraph further comprising controlling a recycle stream from the separator to the hydrogenation reactor and a product stream using a level controller on the separator, a recycle flow controller, and a product flow controller. An embodiment of the invention is one, any or all of prior embodiments in this paragraph up through the second embodiment in this paragraph wherein the heat source comprises a steam heater, fired heater, hot oil heater, electric heater, or combinations thereof, and wherein the first cooling source or the second cooling source or both comprises a steam generator, a heat exchanger, fired heater, hot oil heater, electric heater, or combinations thereof.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

What is claimed is:

1. A process for controlling a liquid organic hydrogen carrier (LOHC) process comprising:
measuring a pressure of a separator;
controlling a hydrogenation reactor using a first pressure controller and a first differential temperature controller based on the measured pressure of the separator;
measuring an inlet temperature or an outlet temperature or both of the hydrogenation reactor;
controlling the inlet temperature of the hydrogenation reactor using a first inlet temperature controller and a heat source or a cooling source based on the measured inlet temperature;
controlling a flow rate of hydrogen to the hydrogenation reactor using a hydrogen flow controller and a second pressure controller limiting a flow rate of a source of hydrogen; and
controlling a differential temperature of the hydrogenation reactor using a toluene flow controller and the measured inlet temperature and the measured outlet temperature of the hydrogenation reactor.

2. The process of claim 1 further comprising:
selecting a predetermined maximum temperature and a predetermined minimum temperature for the hydrogenation reactor; and
overriding the first inlet temperature controller if the measured temperature is greater than the predetermined maximum temperature or if the measured temperature is less than the predetermined minimum temperature.

3. The process of claim 1 further comprising:
selecting a predetermined maximum temperature rate of change and a predetermined minimum temperature rate of change for the hydrogenation reactor;
determining a temperature rate of change for the hydrogenation reactor; and
overriding the first inlet temperature controller if the determined temperature rate of change is greater than the predetermined maximum temperature rate of change or if the determined temperature rate of change is less than the predetermined minimum temperature rate of change.

4. The process of claim 1
wherein controlling the differential temperature of the hydrogenation reactor comprises controlling a toluene flow rate into the hydrogenation reactor based on a difference between the measured inlet temperature and the measured outlet temperature.

5. The process of claim 1 further comprising:
selecting a predetermined maximum temperature differential and a predetermined minimum temperature differential between the inlet temperature and the outlet temperature of the hydrogenation reactor;
determining a temperature differential between the measured inlet temperature and the measured outlet temperature of the hydrogenation reactor; and
overriding the first differential temperature controller if the temperature differential is greater than the predetermined maximum temperature differential or the temperature differential is less than the predetermined minimum temperature differential.

6. The process of claim 1 further comprising:
selecting a predetermined maximum pressure and a predetermined minimum pressure for the separator; and
overriding the first pressure controller or the second pressure controller or both if the measured pressure is greater than the predetermined maximum pressure or if the measured pressure is less than the predetermined minimum pressure.

7. The process of claim 1 further comprising:
controlling a recycle stream from the separator to the hydrogenation reactor using a level controller on the separator and a recycle flow controller.

8. The process of claim 1 further comprising:
controlling a recycle stream from the separator to the hydrogenation reactor and a product stream using a level controller on the separator, a recycle flow controller, and a product flow controller.

9. The process of claim 1 wherein the heat source comprises a steam heater, fired heater, hot oil heater, electric heater, or combinations thereof, and wherein the cooling source comprises a heat exchanger with a process stream having a lower temperature than the measured temperature.

10. The process of claim 1 further comprising:
controlling a temperature of a second hydrogenation reactor using the first pressure controller and a second differential temperature controller based on the measured pressure of the separator;
measuring an inlet temperature or an outlet temperature or both of the second hydrogenation reactor;
controlling the inlet temperature of the second hydrogenation reactor using a second inlet temperature controller and a second cooling source based on the measured temperature; and
controlling a differential temperature of the second hydrogenation reactor using a second toluene flow controller and the measured inlet temperature and the measured outlet temperature of the second hydrogenation reactor.

11. The process of claim 10 wherein the second cooling source comprises a steam generator, a heat exchanger, fired heater, hot oil heater, electric heater, or combinations thereof.

12. A process for controlling a liquid organic hydrogen carrier (LOHC) process comprising:
measuring a pressure of a separator;
controlling a hydrogenation reactor using a first pressure controller and a first differential temperature controller based on the measured pressure of the separator;
measuring an inlet temperature or an outlet temperature or both of the hydrogenation reactor;
controlling an inlet temperature of the hydrogenation reactor using a first inlet temperature controller and a heat source or a cooling source based on the measured inlet temperature;
controlling a flow rate of hydrogen to the hydrogenation reactor using a hydrogen flow controller and a second pressure controller limiting a flow rate of a source of hydrogen;
controlling differential temperature of the hydrogenation reactor using a toluene flow controller and the measured inlet temperature and the measured outlet temperature of the hydrogenation reactor;
controlling an inlet temperature of a second hydrogenation reactor using the first pressure controller and a second differential temperature controller based on the measured pressure of the separator;
measuring an inlet temperature or an outlet temperature or both of the second hydrogenation reactor;
controlling the inlet temperature of the second hydrogenation reactor using a second inlet temperature controller and a second cooling source based on the measured temperature;
controlling a differential temperature of the second hydrogenation reactor using a second toluene flow controller and the measured inlet temperature and the measured outlet temperature of the second hydrogenation reactor.

13. The process of claim 12 further comprising:
selecting a predetermined maximum temperature and a predetermined minimum temperature for the hydrogenation reactor; and
overriding the first inlet temperature controller if the measured temperature is greater than the predetermined maximum temperature or if the measured temperature is less than the predetermined minimum temperature.

14. The process of claim 12 further comprising:
selecting a predetermined maximum temperature rate of change and a predetermined minimum temperature rate of change for the hydrogenation reactor;
determining a temperature rate of change for the hydrogenation reactor; and
overriding the first inlet temperature controller if the determined temperature rate of change is greater than the predetermined maximum temperature rate of change or if the determined temperature rate of change is less than the predetermined minimum temperature rate of change.

15. The process of claim 12:
wherein controlling the differential temperature of the hydrogenation reactor comprises controlling a toluene flow rate into the hydrogenation reactor based on a difference between the measured inlet temperature and the measured outlet temperature.

16. The process of claim 12 further comprising:
selecting a predetermined maximum temperature differential and a predetermined minimum temperature differential between the inlet temperature and the outlet temperature of the hydrogenation reactor;
determining a temperature differential between the measured inlet temperature and the measured outlet temperature of the hydrogenation reactor; and
overriding the first differential temperature controller if the temperature differential is greater than the predetermined maximum temperature differential or the temperature differential is less than the predetermined minimum temperature differential.

17. The process of claim 12 further comprising:
selecting a predetermined maximum pressure and a predetermined minimum pressure for the separator; and
overriding the first pressure controller or the second pressure controller or both if the measured pressure is greater than the predetermined maximum pressure or if the measured pressure is less than the predetermined minimum pressure.

18. The process of claim 12 further comprising:
controlling a recycle stream from the separator to the hydrogenation reactor using a level controller on the separator and a recycle flow controller.

19. The process of claim 12 further comprising:
controlling a recycle stream from the separator to the hydrogenation reactor and a product stream using a level controller on the separator, a recycle flow controller, and a product flow controller.

20. The process of claim 12 wherein the heat source comprises a steam heater, fired heater, hot oil heater, electric heater, or combinations thereof, and wherein the first cooling source or the second cooling source or both comprises a steam generator, a heat exchanger, fired heater, hot oil heater, electric heater, or combinations thereof.
